(19) United States
(12) Patent Application Publication
(10) Pub. No.: US 2024/0162409 A1
(43) Pub. Date: May 16, 2024

(54) METHOD OF PRODUCING ELECTRODE, AND ELECTRODE

(71) Applicant: Toyota Jidosah Kabushiki Kaisha, Toyota-shi Aichi-ken (JP)

(72) Inventor: Tomoya MESUDA, Toyota-shi Aichi-ken (JP)

(73) Assignee: Toyota Jidosah Kabushiki Kaisha, Toyota-shi Aichi-ken (JP)

(21) Appl. No.: 18/219,190

(22) Filed: Jul. 7, 2023

(30) Foreign Application Priority Data
Sep. 8, 2022 (JP) 2022-142946

(51) Int. Cl. H01M 4/131; H01M 4/1391; H01M 4/02; H01M 4/505; H01M 4/525; H01M 4/62; H01M 4/66

(52) U.S. Cl. CPC H01M 4/131; H01M 4/1391; H01M 2004/021; H01M 4/505; H01M 4/525; H01M 4/623; H01M 4/661

(57) ABSTRACT

A method of producing an electrode includes: (a) forming an active material layer; and (b) forming a groove on a surface of the active material layer by laser processing of the surface of the active material layer. In the laser processing, a pulsed laser having a pulse width of 200 ns or less is used; an ambient pressure is 980 hPa or more; and assist gas has a flow rate of 5 m/s or less.

### CROSS REFERENCE TO RELATED APPLICATIONS

This nonprovisional application is based on Japanese Patent Application No. 2022-142946 filed on Sep. 8, 2022, with the Japan Patent Office, the entire contents of which are hereby incorporated by reference.

### BACKGROUND OF THE DISCLOSURE

### Field of the Disclosure

The present disclosure relates to a method of producing an electrode, and to an electrode.

### Description of the Background Art

Japanese Patent Laying-Open No. 2013-097925 discloses forming a recess by irradiating the surface of an active material layer with a laser.

### SUMMARY OF THE DISCLOSURE

Generally, an electrode of a battery includes an active material layer. The active material layer is porous. Into the active material layer, electrolyte solution may permeate. When the permeation of electrolyte solution is insufficient, cycling performance and/or the like may be impaired, for example. In order to facilitate permeation of electrolyte solution, it is suggested to form a groove (a recess) on the surface of the active material layer. This is because the groove may serve as a channel for electrolyte solution to flow, and thereby facilitate permeation of electrolyte solution. However, improvement of cycling performance is not enough, and further improvement of performance has been still demanded.

To address this problem, the present disclosure has an object to reduce reaction resistance.

Hereinafter, the technical configuration and effects of the present disclosure will be described. It should be noted that the action mechanism according to the present specification includes presumption. The action mechanism does not limit the technical scope of the present disclosure.

1. A method of producing an electrode comprises the following (a) and (b):
(a) forming an active material layer; and
(b) forming a groove on a surface of the active material layer by laser processing of the surface of the active material layer. In the laser processing, a pulsed laser having a pulse width of 200 ns or less is used. The ambient pressure is 980 hPa or more. In addition, assist gas has a flow rate of 5 m/s or less.

Generally in laser processing, the processing target can degrade and thereby a by-product can be produced. The by-product can become deposited on the processed part. Usually, from the viewpoint of contamination prevention and the like, the by-product is removed. More specifically, assist gas is used at the time of laser processing and it can blow the by-product away. In an atmosphere under reduced pressure, the by-product can be removed by suction.

Conventionally, it is suggested to form a groove with a microsecond pulsed laser, for example. According to a novel finding of the present disclosure, irradiation of the active material layer with a pulsed laser having a pulse width of 200 ns or less may create a nanostructure as a by-product. The resulting nanostructure may be readily removed by assist gas and the like.

However, under particular conditions, the nanostructure may not be removed and rather deposited on the inner surface of the groove. According to a further finding of the present disclosure, deposition of the nanostructure on the inner surface of the groove is expected to reduce reaction resistance. By the deposition of the nanostructure, the surface area of the active material layer may be markedly increased. That is, the reaction area may be markedly increased, which may reduce reaction resistance.

Furthermore, it may further facilitate permeation of electrolyte solution. It is because a group of the nanostructures may form fine projections and depressions on the inner surface of the groove to bring about capillary action.

2. In the method of producing an electrode according to “1” above, by irradiation of the pulsed laser, the surface of the active material layer may be modified, and thereby a nanostructure may be created. The nanostructure may be deposited on an inner surface of the groove to form a nanostructure layer.

The formation of the nanostructure layer is expected to facilitate capillary action, for example.

3. An electrode includes an active material layer. A groove is formed on a surface of the active material layer. At least part of an inner surface of the groove is covered with a nanostructure layer. The nanostructure layer includes a nanostructure.

With the inner surface of the groove covered with the nanostructure layer, the surface area of the active material layer may be markedly increased. As a result, the reaction area may be increased, and thereby reaction resistance may be reduced. Further, capillary action may occur in the nanostructure layer to facilitate permeation of electrolyte solution.

4. In the electrode according to “3” above, the nanostructure layer may have a thickness from 1 to 10 lam, for example.

5. In the electrode according to “3” or “4” above, the nanostructure may have a Feret diameter from 10 to 300 nm, for example.

6. In the electrode according to any one of “3” to “5” above, the active material layer has a first chemical composition. The nanostructure has a second chemical composition. The second chemical composition has a smaller oxygen composition ratio and a smaller carbon composition ratio than the first chemical composition.

It seems that the nanostructure is formed of the active material layer. During the formation of the nanostructure, oxygen and carbon among the constituents of the active material layer may be partially lost.

Next, an embodiment of the present disclosure (which may also be simply called “the present embodiment” hereinafter) and an example of the present disclosure (which may also be simply called “the present example” hereinafter) will be described. It should be noted that neither the present embodiment nor the present example limits the technical scope of the present disclosure. The present embodiment and the present example are illustrative in any respect. The present embodiment and the present example are non-restrictive. The technical scope of the present disclosure encompasses any modifications within the meaning and the scope equivalent to the terms of the claims. For example, it is originally planned that certain configurations of the present embodiment and the present example can be optionally combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic flowchart for a method of producing an electrode according to the present embodiment.

FIG. 2 is a schematic view of an electrode according to the present embodiment.

FIG. 3 is a schematic cross-sectional view of an electrode according to the present embodiment.

FIG. 4 is a cross-sectional SEM image of an active material layer in No. 1.

FIG. 5 is an enlarged image of a nanostructure layer.

### DESCRIPTION OF THE EMBODIMENTS

### Terms and Definitions Thereof, Etc

Expressions such as “comprise”, “include”, and “have”, and other similar expressions (such as “be composed of”, for example) are open-ended expressions. In an open-ended expression, in which an additional component may or may not be further included. The expression “consist of” is a closed-end expression. However, even when a closed-end expression is used, impurities present under ordinary circumstances as well as an additional element irrelevant to the technique according to the present disclosure are not excluded. The expression “consist essentially of” is a semiclosed-end expression. A semiclosed-end expression tolerates addition of an element that does not substantially affect the fundamental, novel features of the technique according to the present disclosure.

Expressions such as “may” and “can” are not intended to mean “must” (obligation) but rather mean “there is a possibility” (tolerance).

A numerical range such as “from m to n %” includes both the upper limit and the lower limit. That is, “from m to n %” means a numerical range of “not less than m % and not more than n %”. Moreover, “not less than m % and not more than n %” includes “more than m % and less than n %”. Further, any numerical value selected from a certain numerical range may be used as a new upper limit or a new lower limit. For example, any numerical value from a certain numerical range may be combined with any numerical value described in another location of the present specification or in a table or a drawing to set a new numerical range.

Regarding a plurality of steps, operations, processes, and the like that are included in various methods, the order for implementing those things is not limited to the described order, unless otherwise specified. For example, a plurality of steps may proceed simultaneously. For example, a plurality of steps may be implemented in reverse order.

Any geometric term (such as “parallel”, “vertical”, and “perpendicular”, for example) should not be interpreted solely in its exact meaning. For example, “parallel” may mean a geometric state that is deviated, to some extent, from exact “parallel”. Any geometric term herein may include tolerances and/or errors in terms of design, operation, production, and/or the like. The dimensional relationship in each figure may not necessarily coincide with the actual dimensional relationship. The dimensional relationship (in length, width, thickness, and the like) in each figure may have been changed for the purpose of assisting the understanding of the present disclosure. Further, a part of a configuration may have been omitted.

All the numerical values are regarded as being modified by the term “about”. The term “about” may mean±5%, ±3%, ±1%, and/or the like, for example. Each numerical value may be an approximate value that can vary depending on the implementation configuration of the technique according to the present disclosure. Each numerical value may be expressed in significant figures. Each measured value may be the average value obtained from multiple measurements performed. The number of measurements may be 3 or more, or may be 5 or more, or may be 10 or more. Generally, the greater the number of measurements is, the more reliable the average value is expected to be. Each measured value may be rounded off based on the number of the significant figures. Each measured value may include an error occurring due to an identification limit of the measurement apparatus, for example.

When a compound is represented by a stoichiometric composition formula (such as “LiCoO₂”, for example), this stoichiometric composition formula is merely a typical example of the compound. The compound may have a non-stoichiometric composition. For example, when lithium cobalt oxide is represented as “LiCoO₂”, the composition ratio of lithium cobalt oxide is not limited to “Li/Co/O=1/1/2” but Li, Co, and O may be included in any composition ratio, unless otherwise specified. Further, doping with a trace element and/or substitution may also be tolerated.

The chemical composition of the active material layer and the nanostructure (“a first chemical composition” and “a second chemical composition”) may be identified by SEM-EDX (Scanning Electron Microscope-Energy Dispersive X-ray Spectrometry).

“Feret diameter” is measured in a two-dimensional image (such as an SEM image, for example) of nanostructures. The arithmetic mean of the maximum Feret diameters of twenty or more nanostructures is regarded as “the Feret diameter”.

“Electrode” collectively refers to a positive electrode and a negative electrode. Electrode may be a positive electrode, a negative electrode, or a bipolar electrode.

Electrode is for a battery. Lithium-ion battery is merely an example of a battery. The present disclosure may be applied to any battery system.

<Method of Producing Electrode>

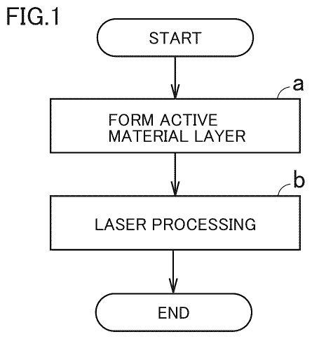

FIG. 1 is a schematic flowchart for a method of producing an electrode according to the present embodiment. Hereinafter, “the method of producing an electrode according to the present embodiment” may also be simply called “the present production method”. The present production method includes “(a) forming an active material layer” and “(b) laser processing”.

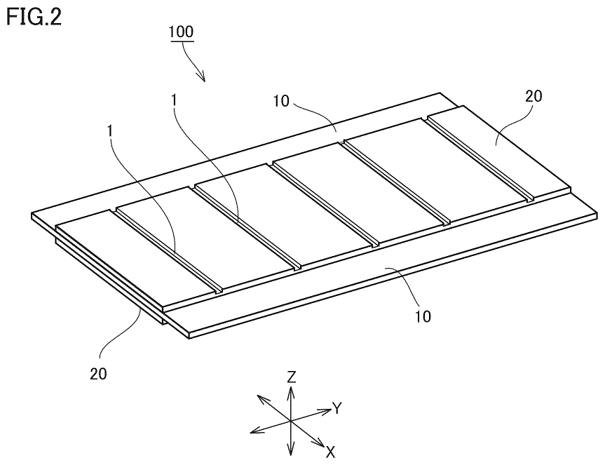

FIG. 2 is a schematic view of an electrode according to the present embodiment.

In the present production method, an electrode 100 is produced. Electrode 100 has a groove 1 on the surface of an active material layer 20.

<<(a) Forming Active Material Layer>>

The present production method includes forming active material layer 20. Active material layer 20 may be formed by any method. For example, active material layer 20 may be formed on the surface of a base material 10.

Base material 10 supports active material layer 20. Base material 10 may be in sheet form, for example. Base material 10 may have a thickness from 5 to 50 μm, for example. Base material 10 may be a current collector, for example. Base material may be a metal foil, for example. The metal foil may include, for example, at least one selected from the group consisting of Al, Cu, Ni, Cr, and Fe. Base material 10 may include an Al foil, an Al alloy foil, a Cu foil, and/or the like, for example.

For example, active material layer 20 may be formed by applying a coating material to the surface of base material 10. For example, the coating material may be formed by mixing an active material, a conductive material, a binder, and a dispersion medium. The dispersion medium may include water, N-methyl-2-pyrrolidone (NMP), butyl butyrate, tetralin, and/or the like, for example. The coating material may be applied with a die coater and/or the like, for example. The coating material may be dried in a hot-air drying furnace and/or the like, for example. After the coating material is dried, active material layer 20 may be compressed. Active material layer may be compressed with the use of a roll-press apparatus, for example. Active material layer 20 may be formed so that it has a thickness from 10 to 1000 μm, for example. Active material layer 20 may be formed so that it has a density from 1 to 4 g/cm³, for example.

An active material causes electrode reaction. The active material may be a positive electrode active material. The positive electrode active material may include any component. The positive electrode active material may include, for example, at least one selected from the group consisting of LiCoO₂, LiNiO₂, LiMnO₂, LiMn₂O₄, Li(NiCoMn)O₂, Li(NiCoAl)O₂, Li(NiCoMnAl)O₂, and LiFePO₄. “(NiCoMn)” in “Li(NiCoMn)O₂”, for example, means that the constituents within the parentheses are collectively regarded as a single unit in the entire composition ratio. As long as (NiCoMn) is collectively regarded as a single unit in the entire composition ratio, the amounts of individual constituents are not particularly limited.

The active material may be a negative electrode active material. The negative electrode active material may include any component. The negative electrode active material may include, for example, at least one selected from the group consisting of natural graphite, artificial graphite, soft carbon, hard carbon, Si, SiOₓ (0<x<2), Si-based alloy, Sn, SnOₓ (0<x<2), Li, Li-based alloy, and Li₄Ti₅O₁₂. SiOₓ (0<x<2) may be doped with Mg and/or the like, for example. By having an alloy-based active material (such as Si, for example) supported by a carbon-based active material (such as graphite, for example), a composite material may be formed.

The conductive material may form an electron conduction path in active material layer 20. The amount of the conductive material to be used may be, for example, from 0.1 to 10 parts by mass relative to 100 parts by mass of the active material. The conductive material may include any component. The conductive material may include, for example, at least one selected from the group consisting of carbon black (CB), vapor grown carbon fiber (VGCF), carbon nanotube (CNT), and graphene flake (GF). CB may include, for example, at least one selected from the group consisting of acetylene black (AB), Ketjenblack (registered trademark), and furnace black.

The binder is capable of binding the solid materials to each other. The amount of the binder to be used may be, for example, from 0.1 to 10 parts by mass relative to 100 parts by mass of the active material. The binder may include any component. The binder may include, for example, at least one selected from the group consisting of polyvinylidene difluoride (PVdF), vinylidene difluoride-hexafluoropropylene copolymer (PVdF-HFP), styrene-butadiene rubber (SBR), butadiene rubber (BR), and polytetrafluoroethylene (PTFE).

<<(b) Laser Processing>>

The present production method includes forming groove 1 on the surface of active material layer 20 by laser processing of the surface of active material layer 20. In the present production method, the laser processing is carried out under particular conditions. As long as it can create the particular conditions, any laser processing apparatus may be used.

The pulsed laser has a pulse width of 200 ns or less. When the pulse width is more than 200 ns, a nanostructure may not be created. The pulse width may be 100 ns or less, or 50 ns or less, for example. The pulse width may be 100 fs or more, or 10 ps or more, or 1 ns or more, or 10 ns or more, for example. When the pulse width is from 10 to 100 ns, the amount of nanostructure creation tends to be high.

The laser processing may be carried out inside a chamber that is capable of controlling the ambient pressure. The pressure inside the chamber may be reduced with the use of a vacuum pump, for example. The ambient pressure is 980 hPa or more. When the ambient pressure is less than 980 hPa, the nanostructure may not be deposited and rather discharged out of the system. The ambient pressure may be 1200 hPa or less, or 1100 hPa or less, or 1050 hPa or less, or 1013 hPa or less, or 1005 hPa or less, for example. The ambient pressure may be from 980 to 1005 hPa, for example.

The assist gas may include air, nitrogen, argon, helium, and/or the like, for example. The assist gas has a flow rate of 5 m/s or less. When the assist gas has a flow rate of more than 5 m/s, the nanostructure may not be deposited and rather discharged out of the system. The flow rate of the assist gas may be 3 m/s or less, or 1 m/s or less, or zero, for example. That is, it may be unnecessary to use assist gas at the time of laser processing.

The laser may be either a fundamental wave or a harmonic. The wavelength of the laser may be from 100 to 1100 nm, for example. The output of the laser may be from 0.01 to 10 W, or from 0.1 to 1 kW, for example. The beam diameter of the laser may be from 1 to 100 lam, for example.

<Electrode>

With the formation of groove 1, electrode 100 may be completed (see FIG. 2). Electrode 100 includes base material 10 and active material layer 20. Active material layer 20 is on the surface of base material 10. Active material layer 20 may be on only one side of base material 10. Active material layer 20 may be on both sides of base material 10. At the periphery of electrode 100, base material 10 may be exposed from active material layer 20. To the part of base material 10 exposed from active material layer 20, a current-collecting member (a lead, a terminal) and/or the like may be connected, for example.

On the surface of active material layer 20, groove 1 is formed. Groove 1 may be a dot-like dimple, for example. Groove 1 may be a linear recess, for example.

Groove 1 may linearly extend on the surface of active material layer 20, for example. The linearly-extending groove 1 is expected to facilitate extensive permeation of electrolyte solution. Groove 1 may extend in a straight line, for example. Groove 1 may extend in a curved line, for example. Groove 1 may be branched.

Groove 1 may extend crossing the surface of active material layer 20, for example. Groove 1 may cross active material layer 20 in a widthwise direction (in the X-axis direction), or may cross in a longitudinal direction (in the Y-axis direction), for example. Groove 1 may have an opening on the side surface of active material layer 20, for example. Through the opening, electrolyte solution may flow into groove 1. With the opening thus formed, permeation of electrolyte solution may be facilitated.

Active material layer 20 may have a single groove 1, or may have a plurality of grooves 1. The plurality of grooves 1 may be formed as parallel lines, for example. The “parallel lines” refer to a group of lines that are parallel to each other. The plurality of grooves 1 may be formed in a grid pattern, for example.

The interval (pitch) between adjacent grooves 1 may be from 0.1 to 10 mm, for example. The length of groove 1 may be from 1 to 5000 mm, or from 1 to 1000 mm, for example.

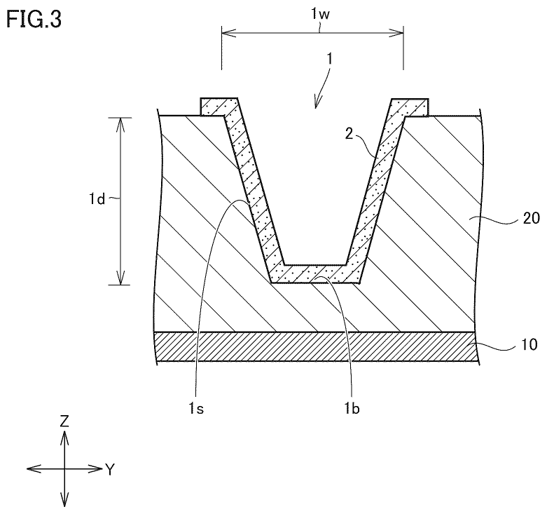

FIG. 3 is a schematic cross-sectional view of an electrode according to the present embodiment. In FIG. 3, a cross section perpendicular to the direction in which groove 1 extends (an extending direction) is shown. Groove 1 may have any cross-sectional profile. The cross-sectional profile of groove 1 may be V-shaped, U-shaped, rectangular, trapezoidal, and/or the like, for example. A cross section of groove 1 may have a bottom portion 1b and a side wall 1s, for example. Bottom portion 1b may be flat, curved, or pointed. Bottom portion 1b is connected to two side walls 1s. These two side walls 1s may be or may not be symmetrically positioned across the line of symmetry, for example. Side wall 1s may extend vertically with respect to the surface of active material layer 20, or may have an angle with respect to the surface of active material layer 20, for example.

The opening may have a width 1w from 10 to 1000 μm, or from 100 to 500 μm, or from 300 to 500 μm, for example. Groove 1 may have a depth 1d from 10 to 100 μm, or from 50 to 100 μm, for example. The ratio of depth 1d of groove 1 to a thickness 20t of active material layer 20 may be from 0.1 to 0.9, or from 0.3 to 0.7, for example.

At least part of the inner surface of groove 1 is covered with a nanostructure layer 2. Nanostructure layer 2 may cover the entire inner surface of groove 1.

Nanostructure layer 2 may cover part of the inner surface of groove 1. Nanostructure layer 2 may extend to the outside of groove 1. Nanostructure layer 2 may extend in such a manner that it covers part of the surface of active material layer 20. The part of active material layer 20 except the inner surface of groove 1 may have no nanostructure.

Nanostructure layer 2 is a group of nanostructures. Nanostructure layer 2 may be formed by deposition of nanostructures on the inner surface of groove 1. Nanostructure layer 2 may have a thickness from 1 to 10 μm, or from 3 to 10 μm, for example.

Nanostructure layer 2 may have nano-scale depressions and projections. Nanostructure layer 2 thus formed may markedly increase the reaction area. As a result, reaction resistance is expected to be reduced. Further, capillary action may occur in nanostructure layer 2 to facilitate permeation of electrolyte solution.

Individual nanostructures that constitute nanostructure layer 2 may have any shape. The nanostructure may be a nanoparticle, for example. The nanostructure may be spherical, rod-like, flake-shaped, fibrous, and/or the like, for example. More specifically, the nanostructure may be a nanosphere, a nanorod, a nanocube, a nanoplate, a nanofiber, a nanotube, and/or the like, for example. Individual nanostructures may be separated from, and independent of, each other. Adjacent nanostructures may be bound to each other.

The nanostructure may have a Feret diameter from 10 to 300 nm, or from 50 to 150 nm, for example. The nanostructures may form nano-scale projections and depressions. The pitch of the projections and depressions formed by the nanostructures (the interval between adjacent projections) may be from 10 to 300 nm, for example.

The chemical composition of the nanostructure may be different from that of active material layer 20. That is, active material layer 20 has a first chemical composition. The nanostructure has a second chemical composition. The second chemical composition may have a smaller oxygen composition ratio and a smaller carbon composition ratio than the first chemical composition. When electrode 100 is a positive electrode, for example, the second chemical composition may have a high composition ratio of transition metal (such as Ni, Co, and Al, for example) than the first chemical composition.

It seems that the difference in chemical composition is caused by pulsed laser irradiation. For example, when some oxygen is released from the positive electrode active material, the oxygen composition ratio may decrease. For example, when some carbon is released from the conductive material, the carbon composition ratio may decrease.

### Examples

<Producing Samples>

<<(a) Forming Active Material Layer>>

The below materials were prepared.
Base material: Al foil
Active material: Li(NiCoMn)O₂
Conductive material: AB
Binder: PVdF
Dispersion medμm: NMP

The active material, the conductive material, the binder, and the dispersion medμm were mixed together to form a coating material. The resulting coating material was applied to the surface of the base material to form an active material layer.

<<(b) Laser Processing>>

Laser processing under various conditions was performed to the surface of the active material layer to produce electrodes of Nos. 1 to 10 (see Table 1 below).

<Evaluation>

A cross section of the active material layer was examined by SEM to check the presence of nanostructures. Results are given in Table 1 below. Further, a battery for evaluation purposes (an evaluation battery) that included the electrode was produced. The evaluation battery is a lithium-ion battery. Battery performance of the evaluation battery was checked. Results are given in Table 1 below.

TABLE 1

| | Laser processing | | | | |
|---|---|---|---|---|---|
| | Pulse | Ambient | Assist gas | Electrode | |
| | width | pressure | flow rate | Nano- | Battery |
| No. | [ns] | [hPa] | [m/s] | structure¹⁾ | performance²⁾ |
| 1 | 50 | 1005 | 0 | P | + |
| 2 | 50 | 10 | 0 | N | − |
| 3 | 50 | 500 | 0 | N | − |
| 4 | 50 | 980 | 0 | P | + |
| 5 | 50 | 980 | 5 | P | + |
| 6 | 50 | 980 | 10 | N | − |
| 7 | 50 | 980 | 20 | N | − |
| 8 | 50 | 1005 | 5 | P | + |
| 9 | 50 | 1005 | 10 | N | − |
| 10 | >200³⁾ | 1005 | 0 | N | − |

¹⁾“P” indicates that the presence of nanostructures on the inner surface of the groove was observed. “N” indicates that no nanostructure was observed.
²⁾“+” indicates that battery performance was enhanced as compared to the reference. “−” indicates that battery performance was degraded as compared to the reference.
³⁾“>200” denotes more than 200 ns.

<Results>

As for Nos. 2, 3, no nanostructure was observed. Due to the ambient pressure being less than 980 hPa, it seemed that a vacuum was created and thereby nanostructures were discharged out of the system.

As for Nos. 6, 7, 9, no nanostructure was observed. Due to the flow rate of the assist gas being more than 5 m/s, it seemed that nanostructures were blown away and discharged out of the system.

As for No. 10, no nanostructure was observed. For No. 10, a pulsed laser with a pulse width of more than 200 ns was used.

As for Nos. 1, 4, 5, 8, nanostructures were observed on the inner surface of the groove. For these samples, the pulse width was 200 ns or less, the ambient pressure was 980 hPa or more, and the flow rate of the assist gas was 5 m/s or less. Battery performance of Nos. 1, 4, 5, 8 (with nanostructures) were high, as compared to Nos. 2, 3, 6, 7, 9, 10 (without nanostructures).

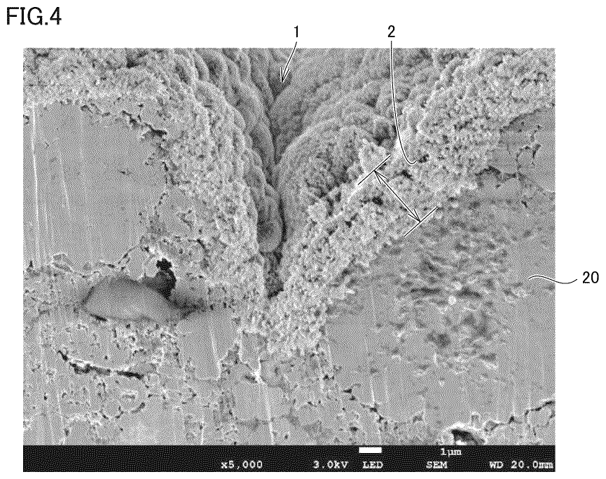

FIG. 4 is a cross-sectional SEM image of the active material layer in No. 1. Groove 1 is formed on the surface of active material layer 20. Nanostructure layer 2 covers the inner surface of groove 1. Nanostructure layer 2 has a thickness from 1 to 10 μm.

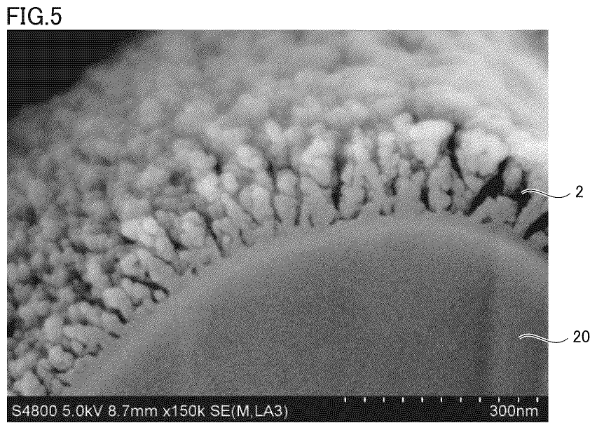

FIG. 5 is an enlarged image of a nanostructure layer. Nanostructure layer 2 is a group of nanostructures. Individual nanostructures have a Feret diameter from 10 to 300 nm. Nanostructure layer 2 has nano-scale projections and depressions. It seems that nanostructure layer 2 thus formed markedly increased the surface area, and, as a result, reaction resistance was reduced and battery performance was enhanced.

The chemical composition of the nanostructure had a smaller oxygen composition ratio and a smaller carbon composition ratio than the chemical composition of active material layer 20.

What is claimed is:

1. A method of producing an electrode, the method comprising:
(a) forming an active material layer; and
(b) forming a groove on a surface of the active material layer by laser processing of the surface of the active material layer, wherein
in the laser processing,
a pulsed laser having a pulse width of 200 ns or less is used,
an ambient pressure is 980 hPa or more, and
assist gas has a flow rate of 5 m/s or less.

2. The method of producing an electrode according to claim 1, wherein
by irradiation of the pulsed laser, the surface of the active material layer is modified, and thereby a nanostructure is created, and
the nanostructure is deposited on an inner surface of the groove to form a nanostructure layer.

3. An electrode comprising:
an active material layer, wherein
a groove is formed on a surface of the active material layer,
at least part of an inner surface of the groove is covered with a nanostructure layer, and
the nanostructure layer includes a nanostructure.

4. The electrode according to claim 3, wherein the nanostructure layer has a thickness from 1 to 10 μm.

5. The electrode according to claim 3, wherein the nanostructure has a Feret diameter from 10 to 300 μm.

6. The electrode according to claim 3, wherein
the active material layer has a first chemical composition,
the nanostructure has a second chemical composition, and
the second chemical composition has a smaller oxygen composition ratio and a smaller carbon composition ratio than the first chemical composition.
